(19) United States
(12) Patent Application Publication
(10) Pub. No.: US 2023/0178895 A1
(43) Pub. Date: Jun. 8, 2023

(54) EXPANDABLE APERTURE COUPLED STACKED PATCH ANTENNA

(71) Applicant: BAE SYSTEMS Information and Electronic Systems Integration Inc., Nashua, NH (US)

(72) Inventors: Alexander D. Johnson, Waltham, MA (US); Jonathan E. Epstein, Acton, MA (US); Jacob Tamasy, Nashua, NH (US)

(73) Assignee: BAE SYSTEMS Information and Electronic Systems Integration Inc., Nashua, NH (US)

(21) Appl. No.: 17/541,452

(22) Filed: Dec. 3, 2021

(51) Int. Cl. H01Q 9/04; H01Q 1/48; H01Q 1/10; H01Q 21/00

(52) U.S. Cl. CPC H01Q 9/0414; H01Q 1/48; H01Q 1/106; H01Q 21/0025

(57) ABSTRACT

A stacked patch antenna is expandable from a thinner stowed configuration in which the gaps between the conductor layers are reduced, to a thicker deployed configuration in which the gaps are expanded to their required dimensions. The expansion mechanism can include rotation of threaded rods, pneumatic expansion of telescoping rods, and/or injection of a gas, a chemical sublimate, and/or an expandable foam into the gaps. In embodiments, the stowed thickness of the antenna can be approximately equal to the sum of the thicknesses of the conductor panels. In some of these embodiments high dielectric layers are not included. In other of these embodiments high dielectric layers are formed by filling gaps with a high dielectric foam. Embodiments implement aperture coupling to the stacked patch antenna. An array of the stacked patch antennae can be folded about a satellite until deployment, and can be planar when unfolded and deployed.

### FIELD

The present disclosure relates to antenna designs and more particularly to antennae that are useful for deployment from space-constrained platforms such as satellites.

### BACKGROUND

Modern sensor platforms are continuously shrinking in size to promote cost effectiveness for higher quantity deployments, especially for volume-constrained platforms. One such example is so-called “small satellites,” or “Small-Sats,” which are a cheaper alternative to traditional satellites that allow for more rapid development cycles at lower cost, thereby providing more available assets to the end-user. These “Small-Sats” can serve a number of communications, ISR (Intelligence, Surveillance, and Reconnaissance), ES (Electronic Surveillance) and EW (Electronic Warfare) functions in the optical, microwave (frequency greater than 1 GHz), and/or Radio-frequency (RF) domains. Each of the microwave and RF functions requires an antenna.

However, volume is always critical in a satellite, and an effective antenna must be comparable to or larger than its operating frequency's wavelength, which in the RF domain (i.e. frequencies below 1 GHz) can range from 30 centimeters to 3 meters and more. Accordingly, it can be useful for a satellite's antenna to be initially stored on or in the satellite in a “stowed” configuration that minimizes the required volume for transit, and to “deploy” the antenna to its full size after the satellite has reached orbit. For this reason, currently implemented antenna solutions for satellite RF communication rely mainly on aperture (dish) antennae, such as parabolic reflectors having a deployable perimeter truss, which can be stowed in transit and then opened up (deployed) in orbit.

However, dish antennae are often plagued by surface roughness and tension issues. Also, dish antenna extend significantly away from the satellite due to the reflector and/or feed, which creates a moment arm that can be a drain on the attitude control of the satellite. Furthermore, the stowed volume of a dish antenna, while less than its deployed volume, can still be significant, thereby limiting the space available for other apparatus within the satellite. This problem is especially critical for Small-Sats.

With reference to FIG. 1A, considerable space can be saved by implementing a substantially flat “microstrip” antenna, such as a “patch” antenna which, it its simplest form, comprises a rectangular or square “patch” 100 of a conductor, usually copper, applied to one side of a dielectric panel 102 such as a circuit board, and fed by a microstrip feed line 104, while a ground plane 106 is provided on the opposing side of the dielectric panel. In addition to saving space within the satellite, a patch antenna also concentrates its mass closer to the center of the satellite as compared to a dish antenna, thereby significantly reducing its moment arm and its impact on attitude control. For clarity of illustration, FIG. 1A is presented as a partially exploded view, in that the ground plane 106 is shown as being separated from the circuit board 102, when in fact it would be applied to the underside of the circuit board 102.

The length of the patch 100 is typically comparable to one half of the center wavelength of the antenna, while the thickness of a simple microstrip patch antenna can typically be very small, thereby allowing such an antenna to be implemented on the surface of a satellite without consuming a significant volume within the satellite.

However, simple patch antennae, such as the design illustrated in FIG. 1A, have limited applicability to some sensor applications, because simple patch antennae typically have narrow bandwidths, while many modern satellite applications require a broadband antenna.

One approach to increasing the bandwidth of a patch antenna is to implement a “stacked” patch antenna design. With reference to FIG. 1B, a stacked patch antenna includes at least two overlapping, spaced-apart conductor patches 100a, 100b implemented above a ground plane 106, typically on separate dielectric substrates 102a, 102b. A stacked patch antenna can be fed, i.e. excited, via any of several different mechanisms, such as by extending a metal feed into the lower patch 100b. In the example of FIG. 1B, the antenna is “aperture coupled,” such that the antenna is excited via a feed line 112 that passes beneath a non-copper “aperture” 110 provided in the ground plane, which is essentially a region of the ground plane 106 below the patches 100a, 100b within which the grounding conductor has been omitted or removed. In the example of FIG. 1B, the ground plane 106 is formed on a separate feed substrate panel 108, with a feed line 112 applied to the opposite side of the panel 108.

Each of the patches 100a, 100b in a stacked patch antenna functions more or less as a separate antenna. As such, the spacing between the patches must be adjusted such that they are in phase coherence, so that their signals will add coherently at the center frequency of the antenna bandwidth. A stacked patch antenna thereby provides higher gain than a single patch antenna, because signals are coherently received and transmitted by more than one patch.

Furthermore, a stacked patch antenna can provide a wider bandwidth than a single patch antenna by stagger-tuning the resonant frequency of each individual patch element. This is accomplished by slightly varying the dimensions of each of the two or more stacked patches 100a, 100b, so that their center frequencies are offset from each other, resulting in a cumulative bandwidth that is “stagger-tuned,” thereby providing a broader bandwidth.

The total gain of a RF sensor can be further increased by implementing an array of stacked patch antennae. For example, FIG. 1C is an exploded view of a four element “cross-shaped” stacked patch antenna array. With reference to FIG. 1D, an array of single patch or stacked patch sub-antennae, such as the example shown in FIG. 1C, can be “folded” about the surfaces of a satellite, such as a cube satellite, and then deployed to a planar configuration when the satellite reaches orbit.

Similarly, FIG. 1E is an exploded view of a stacked patch antenna where the patches are arranged in a single column above a cubical Small Sat (i.e. a “cube sat”) 114, and FIG. 1F illustrates how the two outer patch sub-antennae of the array can be folded down toward the cube-sat 114 during stowage.

The bandwidth ratio (ratio of highest impedance matched frequency to lowest impedance matched frequency) of a stacked patch antenna can be as large as about 2:1, which compares favorably with conventional dish antennae or microstrip patch antennae. In addition, a stacked patch antenna can provide a significant (7-8 dBi, i.e. dB above “isotropic”) unit gain, and the polarization of the antenna can be easily controlled by the patch geometry.

However, because it is necessary to provide significant gaps between the patches so that they will be in additive phase with each other, the thickness of a stacked patch antenna will be relatively large compared to a microstrip patch antenna. For example, the thickness of a two-patch stacked antenna can be as large as one half of the wavelength of its center frequency, and the total thickness for designs that include more than two stacked patches will be proportionally even larger.

With reference to FIG. 2, for mechanical convenience, the required gaps between the layers of a stacked patch antenna are typically filled with dielectric spacer layers 200a, 200b, 202. At the sacrifice of some bandwidth, the thickness of a stacked patch antenna can be reduced by using a higher dielectric material, such as high dielectric printed circuit board (PCB) materials 202, within the gaps between the patches. However, high dielectric PCB materials 202 typically have a higher mass density than low dielectric PCB materials 200a, 200b. As a result, the reduction of thickness provided by a high dielectric material 202 is a trade-off against an increase in antenna weight. In the example of FIG. 2, low dielectric spacer layers 200a, 200b are inserted into each of the gaps, while the lower gap further includes a high dielectric spacer layer 202.

Ultimately, volume and envelope constraints dictate the maximum thickness of a stacked patch antenna. Even if high dielectric spacer layers 202 are included, the large wavelengths at frequencies below 1 GHz require excessive thicknesses that can limit a stacked patch antenna's application to satellites, and especially to Small-Sats.

What is needed, therefore, is a high gain, broadband antenna design that is suitable for satellite applications, including Small-Sats.

### SUMMARY

The present disclosure is a high gain, broadband antenna design that can be implemented on a communication platform. Embodiments are suitable for space-constrained communication platforms, including Small-Sats. The disclosed antenna is an expandable stacked patch antenna having a significantly reduced weight and stowed thickness, while being expanded to its required operating thickness upon deployment.

The disclosed antenna design takes advantage of the fact that much of the thickness of a stacked patch antenna arises from gaps between the patches. In a conventional stacked patch antenna, these gaps are established and maintained by layers of high dielectric PCB materials having high mass densities and typical dielectric constants between 2.0 and 10.0. For weight savings, the disclosed antenna design, when expanded, provides unfilled gaps and/or gaps filled with low and/or high dielectric foams rather than PCB materials. It is notable that when gaps filled with low dielectric foam are included, it is largely as a mechanical convenience, in that the antenna characteristics would not be greatly affected if these layers of low dielectric material were replaced by air-filled or vacuum-filled gaps.

The disclosed antenna design is a stacked patch antenna that can be transitioned by an expansion mechanism from a relatively thinner stowed configuration, in which the gaps between the conductor layers are reduced or eliminated, to a relatively thicker deployed configuration in which the required gaps are provided between the conductor layers. Known approaches to determining the panel and dielectric materials and the gaps between patches can be used when designing embodiments of the present disclosure, such as the approaches and formulae that appear in IEEE TRANSACTIONS ON ANTENNAS AND PROPAGATION, VOL. 46, NO. 9, SEPTEMBER 1998, which is incorporated herein in its entirety for all purposes.

In various embodiments, the expansion mechanism includes rotation of threaded rods, pneumatic expansion of telescoping rods, injection of a gas such as air, CO2 or nitrogen gas into the gaps, injection of a chemical sublimate (e.g. benzoic acid) into the gaps, and/or injection of expandable foams into the gaps.

In some embodiments, layers of foam are not included in the antenna design, such that the thickness of the antenna in its stowed configuration is approximately equal to the sum of the thicknesses of the panels upon which the conductors are deposited. In other embodiments, conventional layers of low and/or high dielectric foam are included in gaps that are not collapsed when the antenna is in the stowed configuration. In still other embodiments where it is desirable to include layers of low and/or high dielectric constant materials within one or more of the gaps, the gaps are nevertheless collapsed in the stowed configuration, and are inflated with low and/or high dielectric foam during deployment of the antenna, such that the thickness of the antenna in its stowed configuration is approximately equal to the sum of the thicknesses of the panels upon which the conductors are deposited.

In various embodiments, the antenna is an antenna assembly that includes a phased array of stacked patch sub-antennae, for example arranged in a cross configuration or in a linear configuration. In some of these embodiments where the communication platform is a satellite, the antenna assembly is folded about the outer surface of the satellite when in the stowed configuration, and is transitioned to a planar configuration in the deployed configuration.

Depending on the embodiment, the antenna can be excited by any mechanism known in the art, such as aperture coupling to the stacked patch antenna, probe feeding the stacked patch antenna, or feeding the stacked patch antenna through a microstrip line.

One general aspect of the present disclosure is an expandable stacked patch antenna that can be implemented on a communication platform for RF communication. The stacked patch antenna includes a ground plane applied to a ground plane panel, a plurality of conducting patches substantially aligned with each other above the ground plane, each of the conducting patches being applied to a patch supporting panel, an RF feed suitable for communication with the stacked patch antenna, and an expansion mechanism configured to transition the plurality of conducting patches from a stowed configuration in which gaps between the ground plane and patch supporting panels are minimized, to a deployed configuration in which the gaps between the ground plane and patch supporting panels are enlarged as needed such that the antenna is optimized for communication over a specified range of RF frequencies.

In embodiments, the RF feed is an aperture coupled to the stacked patch antenna. And in some of these embodiments the expansion mechanism includes at least one rotatable threaded rod configured to adjust at least one of the gaps between the ground plane and patch supporting panels.

In any of the above embodiments, the expansion mechanism can include at least one telescoping, pneumatically extendable rod configured to adjust at least one of the gaps between the ground plane and patch supporting panels when the telescoping rod is extended. In some of these embodiments, the telescoping rod includes at least one locking pin or nub configured to fix and secure a length of the telescoping rod when the telescoping rod is extended.

In any of the above embodiments, the expansion mechanism can include a fluid reservoir containing a fill material, the fluid reservoir being in fluid communication with a thin-walled inflatable container that is inserted within one of the gaps between the ground plane and patch supporting panels, the fluid reservoir and thin-walled inflatable container being configured to expand the gap in which the thin-walled container is inserted when the thin-walled inflatable container is inflated with the fill material. In some of these embodiments, the fill material is one of a gas, a chemical sublimate, an expandable foam, a low dielectric fill material having a dielectric constant of less than 1.2, and a high dielectric fill material having a dielectric constant of greater than 2.

In any of the above embodiments, at least one of the gaps between the ground plane and patch supporting panels can be determined by at least one limiting cable extending between the layers that bound the gap.

In any of the above embodiments, the stacked patch antenna can be an antenna array comprising a plurality of stacked patch sub-antennae. In some of these embodiments, when the stacked patch antenna is in its deployed configuration, the stacked patch sub-antennae are arranged in a planar cross pattern comprising four stacked patch sub-antennae extending in four perpendicular directions from a common center area. And some of these embodiments further include a fifth stacked patch sub-antenna located in the common center area.

In other embodiments where the stacked patch antenna is an antenna array comprising a plurality of stacked patch sub-antennae, when the stacked patch antenna is in its deployed configuration, the stacked patch sub-antennae can be arranged as a single, linear row of stacked patch sub-antennae.

In still other embodiments where the stacked patch antenna is an antenna array comprising a plurality of stacked patch sub-antennae, when the stacked patch antenna is in its deployed configuration, the stacked patch sub-antennae can be arranged as a grid of stacked patch sub-antennae.

In any of the embodiments where the stacked patch antenna is an antenna array comprising a plurality of stacked patch sub-antennae, when the stacked patch antenna is in its stowed configuration, the antenna array can be folded about the communication platform.

A second general aspect of the present invention is method of implementing a high gain broadband antenna on a communication platform. The method includes providing a stacked patch antenna according to claim 1, the stacked patch antenna being in its stowed configuration, incorporating the stacked patch antenna onto and/or into the communication platform, and activating the expansion mechanism of the stacked patch antenna, thereby causing the stacked patch antenna to transition to its deployed configuration.

In some of these embodiments, the communication platform is a satellite, and the expansion mechanism is activated after launch of the satellite into space.

In any of the above embodiments, the expansion mechanism can include a fluid reservoir containing a fill material, the fluid reservoir being in fluid communication with an inflatable thin-walled container that is inserted within one of the gaps between the ground plane and patch supporting panels, the fluid reservoir and thin-walled inflatable container being configured to expand the gap in which the thin-walled container is inserted when the thin-walled inflatable container is inflated with the fill material. In some of these embodiments, the thin-walled container is shaped as a cuboid when inflated with the fill material.

In any of the above embodiments, the expansion mechanism can include at least one of a threaded rod configured to adjust at least one of the gaps between the ground plane and patch supporting panels, and a telescoping, pneumatically extendable rod configured to adjust at least one of the gaps between the ground plane and patch supporting panels when the telescoping rod is extended. And in some of these embodiments, the stacked patch antenna is an antenna array comprising a plurality of stacked patch sub-antennae, and wherein when the stacked patch antenna is in its stowed configuration, the antenna array is folded about the communication platform.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1A is an exploded view of a microstrip antenna of the prior art;

FIG. 1B is an exploded view of a stacked patch antenna of the prior art;

FIG. 1C is an exploded view of a four element, cross-shaped stacked patch antenna array of the prior art, shown in a planar, deployed configuration;

FIG. 1D is a perspective view of the antenna array of FIG. 1C folded about the surfaces of a satellite;

FIG. 1E is an exploded view of a stacked patch antenna of the prior art where the patches are arranged in a single column above a cubical Small Sat;

FIG. 1F is a perspective view that illustrates how the two outer patch sub-antennae of the stacked array of FIG. 1E can be folded down toward the cube-sat 114 during stowage.

FIG. 2 is an exploded view of a stacked patch antenna of the prior art having gaps between the conducting layers that are filled with dielectric spacer layers;

FIG. 3A is a cross-sectional side view of an embodiment of the present invention in which the expansion mechanism includes threaded rods, where the embodiment is shown in a collapsed configuration;

FIG. 3B is a cross-sectional side view of the embodiment of FIG. 3A shown in an expanded, deployed configuration;

FIG. 4A is a cross-sectional side view of an embodiment of the present invention in which the expansion mechanism includes pneumatically expandable telescoping rods, where the embodiment is shown in a collapsed configuration;

FIG. 4B is a cross-sectional side view of the embodiment of FIG. 4A shown in an expanded, deployed configuration;

FIG. 4C is a cross-sectional side view of an embodiment similar to FIG. 4B shown in an expanded, deployed configuration, wherein each of the expanded layers is fixed to one of a plurality of nested inner sections of the telescoping rods;

FIG. 5 is a cross-sectional side view of an embodiment of the present invention in which the expansion mechanism includes thin-walled inflatable containers inserted between the conductive panels, as well as a fill-containing reservoir provided within the satellite that is in fluid communication with the containers; and

FIG. 6 is a cross-sectional side view of an embodiment similar to FIG. 5, but including both a reservoir containing low dielectric material and a separate reservoir containing high dielectric material.

### DETAILED DESCRIPTION

The present disclosure is a high gain, broadband antenna design that can be implemented on a communication platform. Embodiments are, suitable for space constrained platforms, including Small-Sats. The disclosed antenna is an expandable stacked patch antenna having a significantly reduced weight and stowed thickness in which the gaps between the conductor layers are reduced or eliminated, while being expanded upon deployment by an expansion mechanism so as to provide the required gaps between the conductor layers.

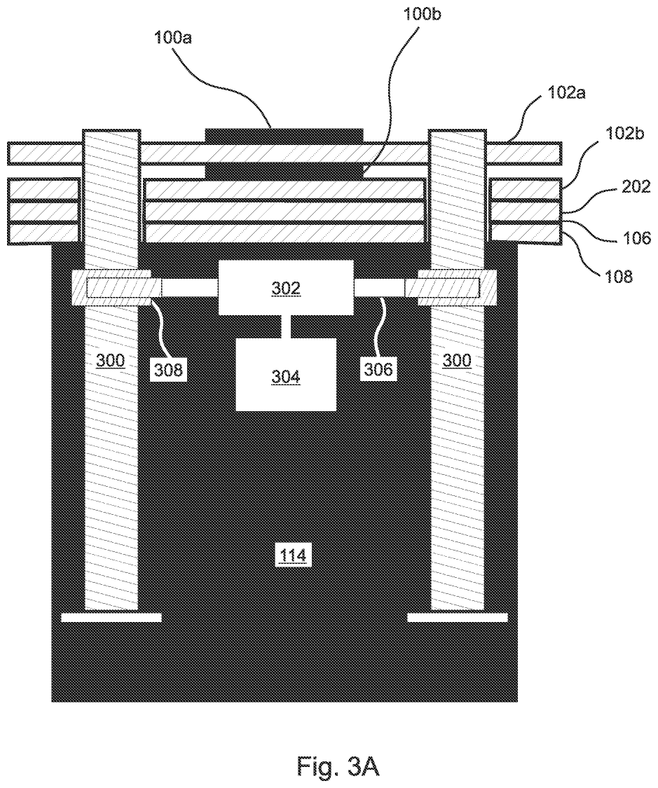

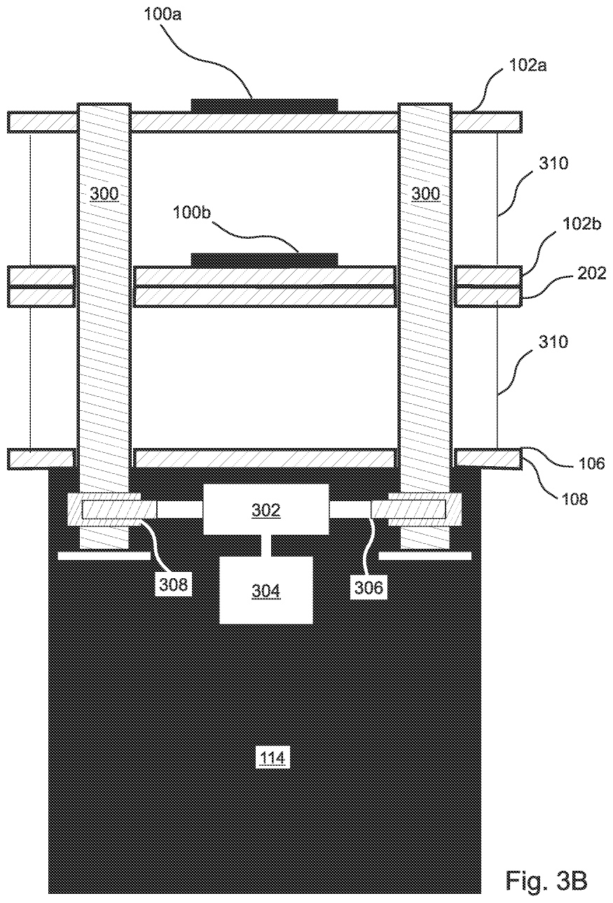

In some embodiments, spacer layers 200a, 200b, 202 are not included in the design, such that the total thickness of the antenna in its stowed configuration is approximately equal to the sum of the thicknesses of the panels 102a, 102b, 106 upon which the conductors are deposited. In the embodiment of FIG. 3A, a high dielectric foam spacer layer 202 is included in the design, and is not compressed in the stowed configuration. Accordingly, the total thickness of the antenna when stowed is the sum of the thicknesses of the panels 102a, 102b, 106 and the high dielectric spacer layer 202.

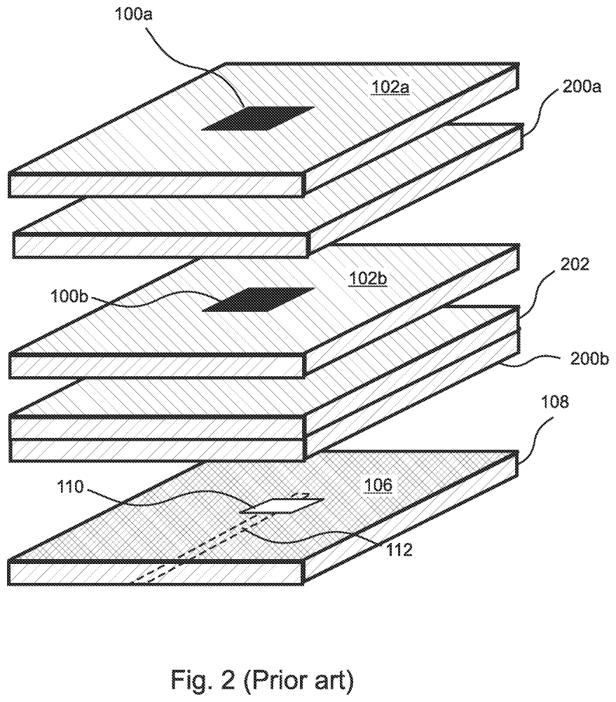

In the embodiment of FIG. 3A, the expansion mechanism includes threaded rods 300. FIG. 3A illustrates the embodiment in the stowed configuration, occupying minimal space and without the added weight of dielectric spacers. In the illustrated embodiment, there are two patches 100a, 100b located on respective high dielectric layer 102a, 102b. There is a high dielectric spacer layer 202 orientated above the ground plane 106 and the entire unit is located inside a cube sat 114. It should be apparent that similar embodiments can include additional patches following the same design. A separate feed substrate panel 108 has an upper surface and a bottom surface with a ground plane 106 on the upper surface with and RF feed 112 (see FIG. 2) applied to the bottom surface of the panel 108. The RF feed is coupled to the receiver or transceiver of the satellite.

During deployment of the antenna of FIG. 3A, the threaded rods 300 are raised and lowered by an electric motor 302 according to instructions received from a controller 304. In the illustrated example, the motor 302 rotates a shaft 306 which is terminated by worm gears that transfer rotation to bushings 308 that are in threaded engagement with the rods 300. The uppermost layer 102a of the patch antenna is fixed to and lifted by the rods 300, while the middle layers 102b, 202 include enlarged holes that allow the threaded rods 300 to pass through. In one example the layers 102a, 102b, 202, 108 are square or rectangular, and there are four threaded rods 300 located in holes in the corners of the layers.

FIG. 3B is a cross sectional side view of the embodiment of FIG. 3A shown after deployment of the antenna. It can be seen in the figure that as the upper layer 102a is lifted by the threaded rods 300, the middle layers 102B, 202 are lifted by limiting cables 310 that extend from the upper layer 102a to the middle layers 102b, 202. Additional limiting cables 310 extend from the middle layers 102b, 202 to the feed substrate panel 108. The gaps between the layers 102a, 102b, 202 are thereby fixed according to the lengths of the limiting cables 310.

In some embodiments, extension of the rods 300 continues until the limiting cables 310 are fully extended or until the rods 300 are fully extended or a stop pin is reached when the optimal spacing is achieved.

In similar embodiments, a separate set of threaded rods is associated with and fixed to each of the layers 102a, 102b, 202, while clearance holes are provided in the other layers as needed, such that all of the layers 102a, 102b, 202 are lifted by their associated threaded rods 300. This approach not only provides for deployment of the antenna, but also enables the gaps to be adjusted after deployment so as to optimize the antenna for different transmit frequencies and bandwidths.

In various embodiments, low dielectric gaps can be filled with are air, a gas such as nitrogen, or a vacuum, since vacuum and virtually all gases and have very similar low dielectric constants.

The optimal spacings between the patches 102a, 102b, 202 and the ground plane 108 are selected so as to provide optimal performance for the desired frequency range. For example, the spacing can be selected such that the radio waves generated by all of the patches add together coherently in the desired transmit direction at the center frequency of the antenna bandwidth or at the highest frequency of the antenna bandwidth. Another approach is to adjust the spacing between patches such that each pair is optimized for a slightly different frequency, thereby “stagger tuning” the antenna and further increasing its bandwidth. Known approaches to determining the panel and dielectric materials and the gaps between patches can be used when designing embodiments of the present disclosure, such as the approaches and formulae that appear in IEEE TRANSACTIONS ON ANTENNAS AND PROPAGATION, VOL. 46, NO. 9, SEPTEMBER 1998, which is incorporated herein in its entirety for all purposes.

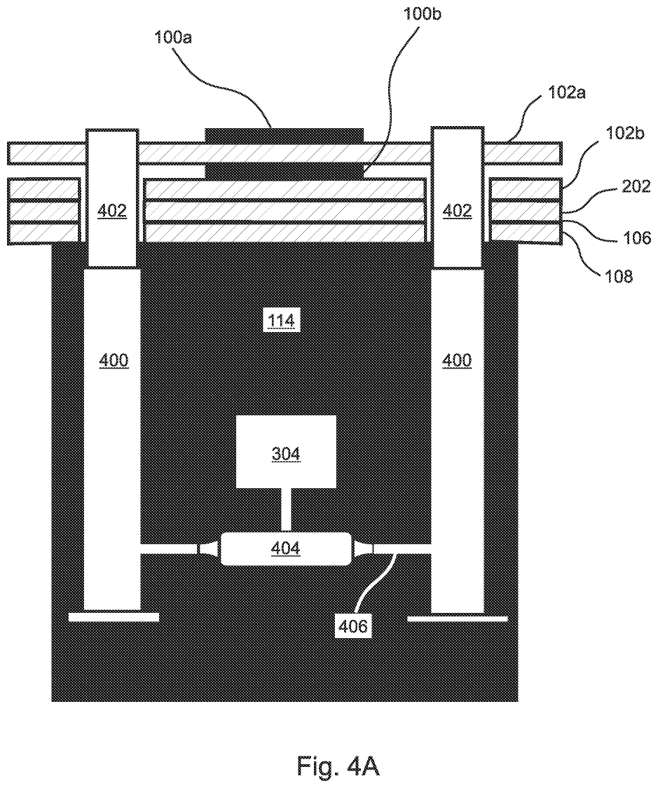

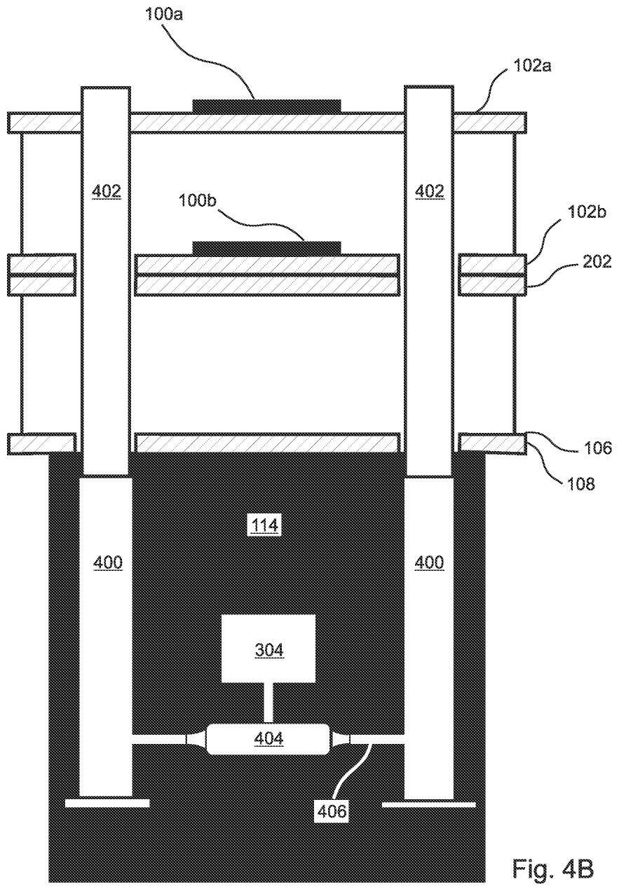

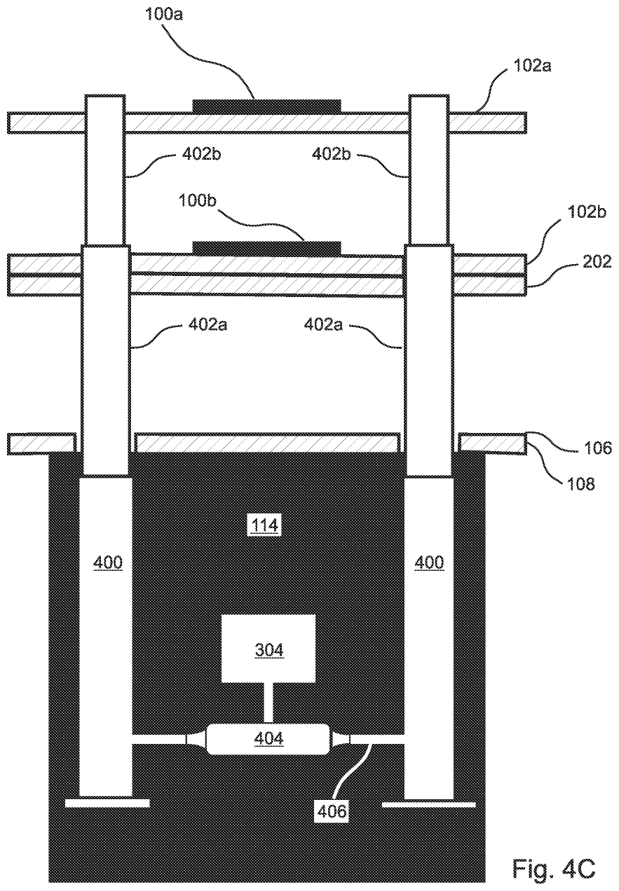

In other embodiments, the expansion mechanism employs pneumatically expandable telescoping rods. In the example of FIG. 4A, each of the telescoping rods includes two concentric sections 400, 402, with the inner section 402 being sealed such that gas from a pressurized gas cylinder 404 in fluid communication with the outer sections 400 via connecting pipes 406 can push the inner section 402 upwards to a pre-defined height. FIG. 4A illustrates the embodiment in its stowed, minimum thickness configuration, while FIG. 4B illustrates the same embodiment after deployment of the antenna. There can be locking pins or nubs on the rods 400, 402 such that the rods 400, 402 are secured in place once deployed to the desired heights. In a manner similar to the example of FIGS. 3A and 3B, the inner telescoping rods 402 are fixed to the uppermost layer 102a, while clearance holes are provided in the middle layers 102b, 202, which are lifted and fixed in position by limiting cables 310.

With reference to FIG. 4C, in similar embodiments separate, nested inner sections 402a, 402b are provided, with each of the nested inner sections 402a, 402b being fixed to one of the expanded layers 102a, 102b, 202. Upon expansion, locking pins or nubs on the rods 400, 402a, 402b ensure that they are deployed to their desired lengths. The lengths of the nested sections 402a, 402b thereby determine the gap spacings.

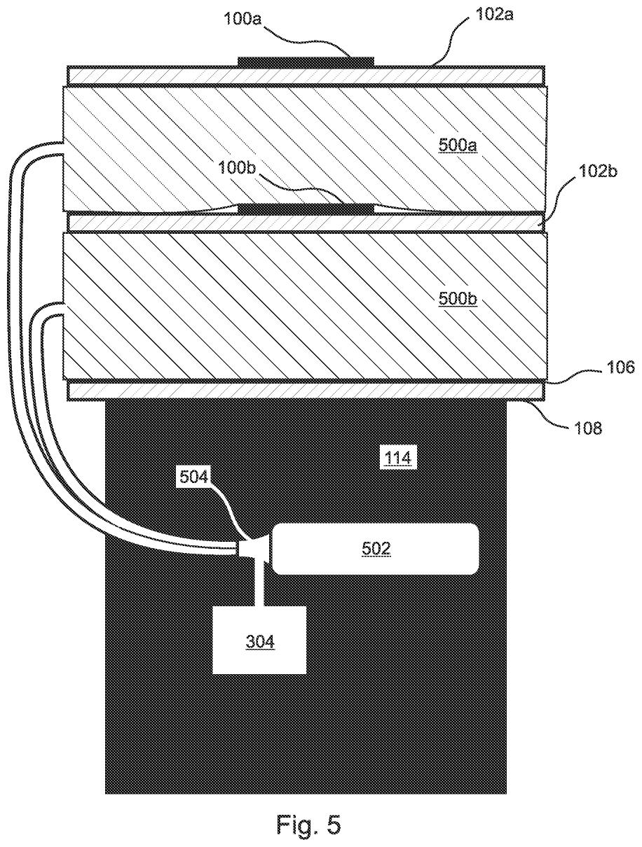

With reference to FIG. 5, in other embodiments the expansion mechanism comprises thin-walled inflatable containers 500a, 500b that are inserted between the panels 102a, 102b, 108 on which the conductors are deposited, as well as at least one reservoir 502 provided within the satellite 114 that is in fluid communication with the containers 500a, 500b and contains a fill material. Deployment of the antenna is accomplished in these embodiments by causing a controller 304 to open a valve 504 so as to inject the fill material from the reservoir 502 into the thin-walled containers 500a, 500b, thereby inflating the thin-walled containers 500a, 500b and separating the panels 102a, 102b, 106 from each other to create the required gaps.

In various embodiments, the fill material is a gas, such as air, carbon dioxide, or nitrogen gas, a low dielectric constant chemical sublimate having a dielectric constant less than 1.2 (e.g. benzoic acid), and/or a low dielectric expandable foam having a dielectric constant that is less than 1.2. Limiting cables (not shown) can also be included between the panels 102a, 102b, 106 to precisely define the maximum size of each of the gaps upon inflation of the thin-walled containers 500a, 500b.

In the embodiment of FIG. 5, the thin-walled containers 500a, 500b are cuboids that fill the gaps in a precisely controlled manner. This approach can be preferred, for example, when the thin-walled containers are to be filled with a high dielectric foam. In other embodiments where the fill material has a low dielectric constant, the thin-walled containers 500a, 500b can take on any shape, in that their function is entirely to separate the layers 102a, 102b, 108, while limiting cables can be used to fix the gap sizes.

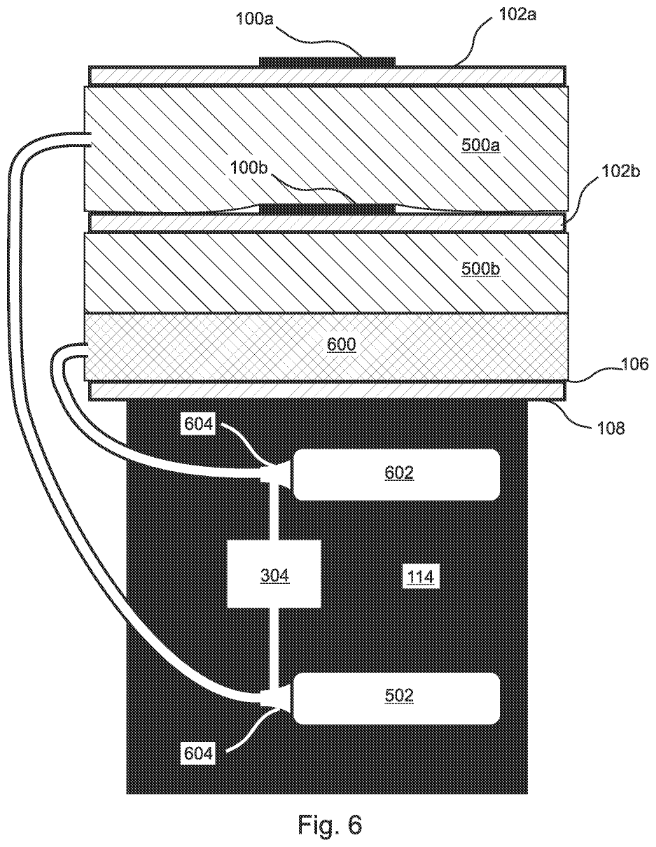

It will be noted that the embodiment of FIG. 5 does not include a high dielectric spacer layer 202. With reference to FIG. 6, in some embodiments where it is desirable to include one or more high dielectric constant spacer layers 600, the expansion mechanism includes a plurality of reservoirs 502, 602 wherein at least one of the reservoirs 600 is filled with a high dielectric fill material, such as a high dielectric foam, having a dielectric constant of greater than 2. Deployment of the antenna in these embodiments includes causing the controller 304 to open both of the valves 604, thereby inflating each of a plurality of thin-walled containers 500a, 500b, 600 with material from the plurality of reservoirs 502, 602. In the illustrated embodiment, two cuboid thin-walled containers 500a, 500b are filled with a low dielectric foam, while a third cuboid thin-walled container 600 is filled with a high dielectric foam. This approach has the advantage of providing a high dielectric spacer layer without significantly increasing the stowed thickness of the antenna.

Depending on the embodiment, the satellite 114 can communicate with the antenna by any mechanism known in the art, such as by extending a microstrip feed line to the primary, bottom-most patch element 108. While not visible in the drawings, the antennae of FIGS. 3-6 include aperture coupled feeds in communication with the satellite 114 in a manner similar to FIG. 2. This approach can simplify the design, in that only a single feed line to each aperture is required, which require no reconfiguration when the antenna is deployed.

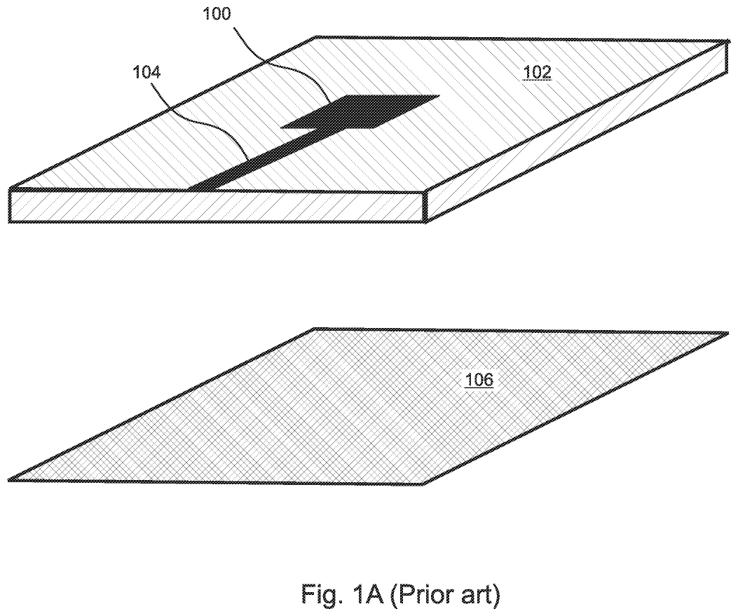

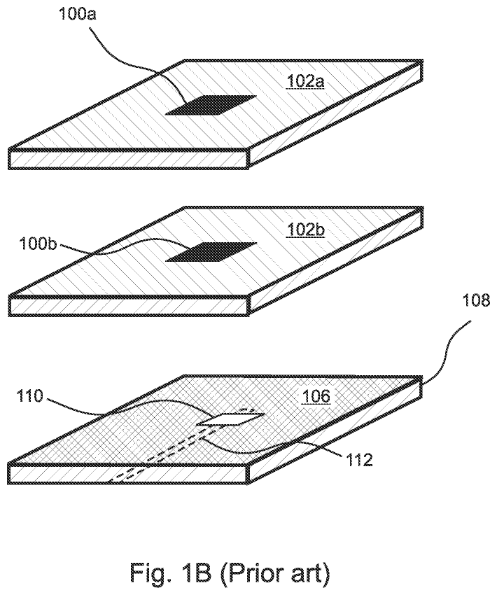

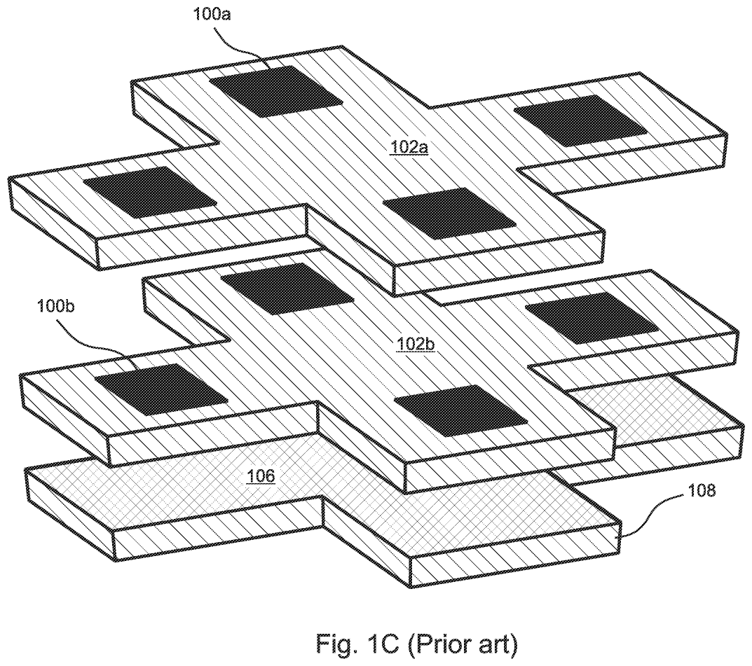

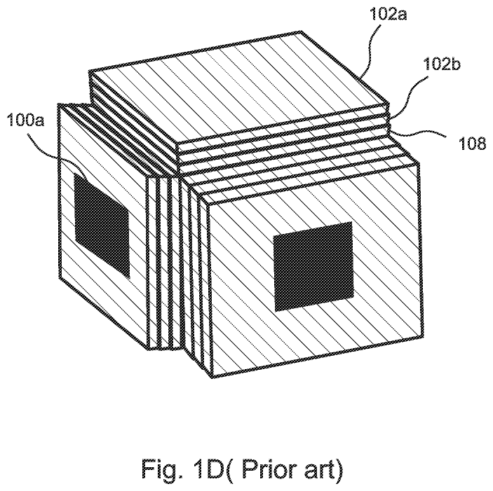

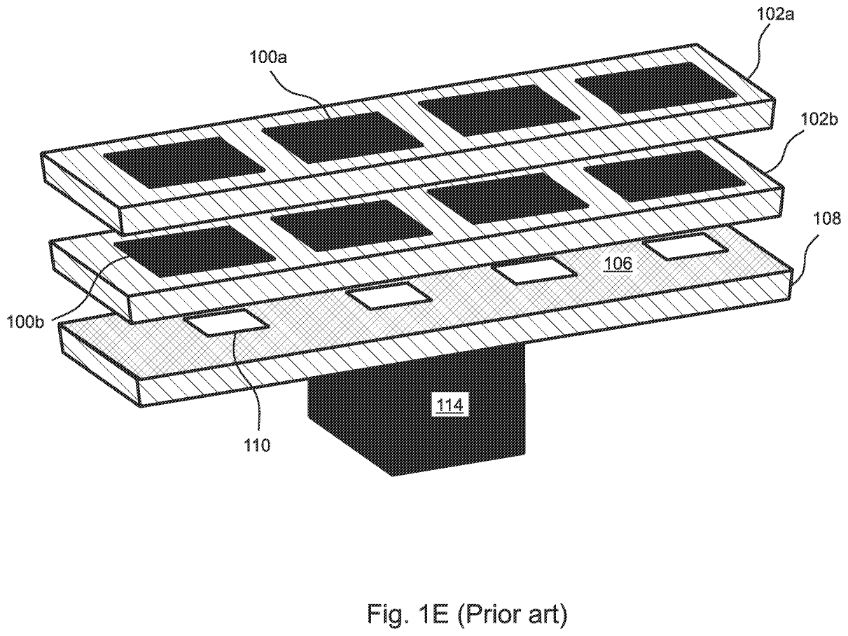

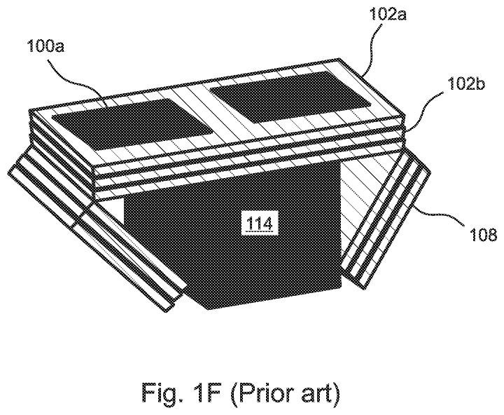

In various embodiments, the disclosed antenna is an antenna assembly that includes a plurality of expandable stacked patch antennae, for example in a manner similar to FIGS. 1C-1F. In the stowed configuration, some of these embodiments include folding of stacked patch antennae toward surfaces of the satellite 114, for example in a manner similar to FIG. 1D or FIG. 1F.

The foregoing description of the embodiments of the disclosure has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the disclosure to the precise form disclosed. Many modifications and variations are possible in light of this disclosure.

Although the present application is shown in a limited number of forms, the scope of the disclosure is not limited to just these forms, but is amenable to various changes and modifications. The disclosure presented herein does not explicitly disclose all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

I claim:

1. An expandable stacked patch antenna that can be implemented on a communication platform for RF communication, the stacked patch antenna comprising:
a ground plane applied to a ground plane panel;
a plurality of conducting patches substantially aligned with each other above the ground plane, each of the conducting patches being applied to a patch supporting panel;
an RF feed suitable for communication with the stacked patch antenna; and
to an expansion mechanism configured to transition the plurality of conducting patches from:
a stowed configuration in which gaps between the ground plane and patch supporting panels are minimized; to
a deployed configuration in which the gaps between the ground plane and patch supporting panels are enlarged as needed such that the antenna is optimized for communication over a specified range of RF frequencies.

2. The stacked patch antenna of claim 1, wherein the RF feed is an aperture coupled to the stacked patch antenna.

3. The stacked patch antenna of claim 1, wherein the expansion mechanism includes at least one rotatable threaded rod configured to adjust at least one of the gaps between the ground plane and patch supporting panels.

4. The stacked patch antenna of claim 1, wherein the expansion mechanism includes at least one telescoping, pneumatically extendable rod configured to adjust at least one of the gaps between the ground plane and patch supporting panels when the telescoping rod is extended.

5. The stacked patch antenna of claim 4, wherein the telescoping rod includes at least one locking pin or nub configured to fix and secure a length of the telescoping rod when the telescoping rod is extended.

6. The stacked patch antenna of claim 1, wherein the expansion mechanism includes a fluid reservoir containing a fill material, the fluid reservoir being in fluid communication with a thin-walled inflatable container that is inserted within one of the gaps between the ground plane and patch supporting panels, the fluid reservoir and thin-walled inflatable container being configured to expand the gap in which the thin-walled container is inserted when the thin-walled inflatable container is inflated with the fill material.

7. The stacked patch antenna of claim 6, wherein the fill material is one of:
a gas;
a chemical sublimate;
an expandable foam;
a low dielectric fill material having a dielectric constant of less than 1.2; and
a high dielectric fill material having a dielectric constant of greater than 2.

8. The stacked patch antenna of claim 1, wherein at least one of the gaps between the ground plane and patch supporting panels is determined by at least one limiting cable extending between the layers that bound the gap.

9. The stacked patch antenna of claim 1, wherein the stacked patch antenna is an antenna array comprising a plurality of stacked patch sub-antennae.

10. The stacked patch antenna of claim 9, wherein when the stacked patch antenna is in its deployed configuration, the stacked patch sub-antennae are arranged in a planar cross pattern comprising four stacked patch sub-antennae extending in four perpendicular directions from a common center area.

11. The stacked patch antenna of claim 10, further comprising a fifth stacked patch sub-antenna located in the common center area.

12. The stacked patch antenna of claim 9, wherein when the stacked patch antenna is in its deployed configuration, the stacked patch sub-antennae are arranged as a single, linear row of stacked patch sub-antennae.

13. The stacked patch antenna of claim 9, wherein when the stacked patch antenna is in its deployed configuration, the stacked patch sub-antennae are arranged as a grid of stacked patch sub-antennae.

14. The stacked patch antenna of claim 9, wherein when the stacked patch antenna is in its stowed configuration, the antenna array is folded about the communication platform.

15. A method of implementing a high gain broadband antenna on a communication platform, the method comprising:
providing a stacked patch antenna according to claim 1, the stacked patch antenna being in its stowed configuration;
incorporating the stacked patch antenna onto and/or into the communication platform; and
activating the expansion mechanism of the stacked patch antenna, thereby causing the stacked patch antenna to transition to its deployed configuration.

16. The method of claim 15, wherein the communication platform is a satellite, and wherein the expansion mechanism is activated after launch of the satellite into space.

17. The method of claim 15, wherein the expansion mechanism includes a fluid reservoir containing a fill material, the fluid reservoir being in fluid communication with an inflatable thin-walled container that is inserted within one of the gaps between the ground plane and patch supporting panels, the fluid reservoir and thin-walled inflatable container being configured to expand the gap in which the thin-walled container is inserted when the thin-walled inflatable container is inflated with the fill material.

18. The method of claim 17, wherein the thin-walled container is shaped as a cuboid when inflated with the fill material.

19. The method of claim 15, wherein the expansion mechanism includes at least one of:
a threaded rod configured to adjust at least one of the gaps between the ground plane and patch supporting panels; and
a telescoping, pneumatically extendable rod configured to adjust at least one of the gaps between the ground plane and patch supporting panels when the telescoping rod is extended.

20. The method of claim 19, wherein the stacked patch antenna is an antenna array comprising a plurality of stacked patch sub-antennae, and wherein when the stacked patch antenna is in its stowed configuration, the antenna array is folded about the communication platform.
